(19) United States
(12) Patent Application Publication
(10) Pub. No.: US 2020/0358951 A1
(43) Pub. Date: Nov. 12, 2020

(54) SYMMETRY BREAKING TRANSLATION FOR MODAL IMAGING

(71) Applicant: Honeywell International Inc., Morris Plains, NJ (US)

(72) Inventors: Lisa Marie Lust, Minneapolis, MN (US); Mary Katherine Salit, Plymouth, MN (US); Jeffrey Michael Klein, Minneapolis, MN (US)

(21) Appl. No.: 16/813,291

(22) Filed: Mar. 9, 2020

Related U.S. Application Data
(60) Provisional application No. 62/846,104, filed on May 10, 2019.

(51) Int. Cl. H04N 5/232; G06T 3/20

(52) U.S. Cl. CPC H04N 5/23229; G06T 3/20

(57) ABSTRACT

A method includes receiving a first modal image based on radiation collected from an object via an aperture, wherein the radiation is separated into the first modal image having an original origin, receiving a second modal image based on radiation collected from the object via the aperture, wherein the radiation is separated into the second modal image having a shifted origin, translating the second modal image to the original origin, and deriving an image of the object as a function of the collective overlap between the first modal image and the translated second modal image. Repeating the process with additional shift images improves the resolution of the final digitally generated image.

### RELATED APPLICATION

This application claims priority to U.S. Provisional Application Ser. No. 62/846,104 (entitled Symmetry Breaking Translation for Modal Imaging, filed May 10, 2019) which is incorporated herein by reference.

### GOVERNMENT FUNDING

This invention was made with Government support under contract FA8650-18-C-9102 awarded by USAF/AFMC. The Government has certain rights in this invention.

### BACKGROUND

To improve the accuracy of images created from radiation collected by apertures from objects, the radiation may be separated into orthogonal modes. Such modes have varying degrees of spatial symmetry about an axis of a Cartesian coordinate system, making it difficult to determine wherein the image appears.

### SUMMARY

A method includes receiving a first modal image based on radiation collected from an object via an aperture, wherein the radiation is separated into the first modal image having an original origin, receiving a second modal image based on radiation collected from the object via the aperture, wherein the radiation is separated into the second modal image having a shifted origin, translating the second modal image to the original origin, and deriving an image of the object as a function of the collective overlap between the first modal image and the translated second modal image. Collecting additional shifts will improve the resolution of the modal image.

### BRIEF DESCRIPTION OF THE DRAWINGS

FIG. 1 is a block diagram of a system for collecting and processing radiation received from an object according to an example embodiment.

FIG. 2 is a simple example showing a sequence of images where two modal images with different translations are combined to reimage an original or actual object according to an example embodiment.

FIG. 3 is a flowchart illustrating a computer implemented method of processing radiation received from an object to obtain an image of the object. according to an example embodiment.

FIG. 4 is a block schematic diagram of a computer system to implement one or more example embodiments.

### DETAILED DESCRIPTION

In the following description, reference is made to the accompanying drawings that form a part hereof, and in which is shown by way of illustration specific embodiments which may he practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

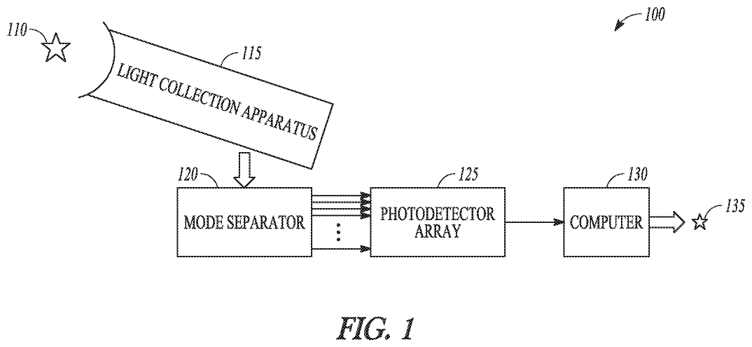

FIG. 1 is a block diagram of a system 100 for collecting and processing radiation (such as light) from an object 110. System 100 includes a light collection apparatus, referred to as an aperture 115 that is pointed at object 110, such as a star or other object. A mode separator 120 is coupled to receive radiation from the aperture 115 and separate that radiation into orthogonal modes. A photodetector array 125 is positioned to receive the separated radiation and provide signals representative of the radiation to a programmed computer 130 to process the light and produce an image of the objection 110.

When the aperture 115 (i.e. telescope, microscope) is directed at the object 110, a portion of the radiation emanated or reflected from that object is collected by the aperture. Past the aperture, first a modal basis is designated such as the physicist Hermite Gauss mathematically defined in Gradshteyn and Ryzhik (8.950), the Laguerre Gauss (Gradshteyn and Ryzhik 8.970), or other physical modal basis. The mode separator 120 separates the radiation into the. orthogonal modes. The intensity of the radiation in the separated modes is then independently measured via photodetector array 125. A modal image is then formed by programmed computer 130 which will intrinsically bare the symmetry of the modal basis.

The separation of the radiation into modal forms results in a functional symmetry such that a Cartesian quadrant of the radiation is not discernable. To break the symmetry, the aperture itself, or the object itself, the system's optics, or the incoming radiation into the aperture (i.e. via atmospheric motion) is shifted slightly retaining the first images' origin. The modal information is recollected. The physical translation is known. The modal image is digitally translated back to the original origin given this known translation. This process is repeated. The collective overlap of the translated images defines the true image.

A series of known spatial translations from a single specified origin are executed. Radiation in the modal basis is then collected for each translation. Each modal image is then re-shifted back to a common origin, where the images are compared as a collective to break the intrinsic symmetry of the modal basis and provide a resolved image.

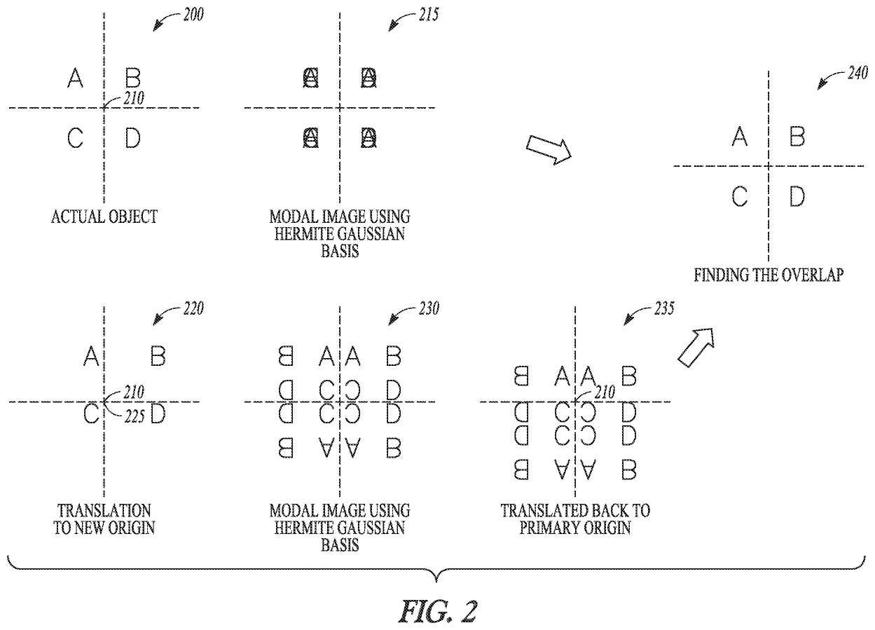

FIG. 2 is a simple example showing a sequence of images where two modal images with different translations are combined to reimage an original or actual object 200. The term “modal images” refers to images produced by first separating the radiation into modal basis, and then measuring the radiation in that basis to form an array of pixels and reconstructing the object through digital analysis of the modal information—pixel arrays. The actual object 200 includes four capital letters, A, B, C, and D in four separate Cartesian quadrants about an origin 210. A first modal image is shown generally at 215 and is generated using Hermite Gaussian (HG) Basis. Since the HG basis is four-fold symmetric the letters can appear in all four quadrants. A single intensity image does not contain enough information to discern which quadrant each letter actually resides inside. While the simple images in FIG. 2 are used, further examples include generating an image of a single object, such as a star, multiple objects, or even complex objects.

The actual object is then translated as shown generally at 220 to a new origin 225. A second modal image 230 is created using Hermite Gaussian Basis from the translated object about the new origin 225. Taken as a single image, once again the exact quadrant each letter resides in is unknown, and thus are duplicated four-fold. The second modal image 230 is then translated back to the original origin 210 as indicated generally at 235.

Mathematically, it can be easily shown that translation can break a symmetrical basis. As an example, if the radiation of some real image Iᵣₑₐₗ(x,y) is separated into a modal four fold symmetric modal basis, such as a Hermite Gaussian then as measured in that basis

I_{modal}(x,y)=Iᵣₑₐₗ(x,y)+Iᵣₑₐₗ(−x,y)+Iᵣₑₐₗ(−x,−y). Eq. 1

Shifting the real image by +666 x,+Δy per one of the methods mentioned earlier results in Iᵣₑₐₗ(x+Δx,y+Δy). Define x′=x+Δx, and y′=y+Δy The modal image then presents itself as

I_{modal}(x′,y′)=Iᵣₑₐₗ(x′,y′)+Iᵣₑₐₗ(−x′,y′)+Iᵣₑₗ(x′,−y′)Iᵣₑₐₗ(−x′,−y′). Eq. 2

By taking this last image and shifting it back to the origin of the first

I_{modal}(x′−Δx,y′−Δy)=Iᵣₑₐₗ(x′−Δx,y′−Δy)+Iᵣₑₐₗ(−x′−Δx,y′−Δy)+Iᵣₑₐₗ(x′−Δx,−y′−Δy)+Iᵣₑₐₗ(−x′−Δx,−y−Δy). Eq. 3

The overlap between Equation 1 and Equation 3 is simply the bolded terms namely,

Two separate modal images have been created based on the actual object, a first modal image 210 with the image at the origin 210 and a second modal image 230 with the origin shifted to new origin 225. At this point, both the first and second modal images 215 and 230 are combined to find their overlap, resulting in a combined image indicated generally at 240. In other words, the combined image is simply the portions of the modal images that overlap. The overlap is thus an AND function of the modal images. The combined image 240 is a very close representation of the actual object 200, with the four letters in the combined image 240 appearing in the four quadrants in the same positions as in the actual object 200.

In some cases, multiple shifts of various magnitudes and direction may be performed to generate multiple modal images which are then combined to determine the actual object and eliminate duplication. For instance, a shift in the x direction may not provide information sufficient to resolve a y quadrant. Thus, multiple shifts in the x and y directions, as well as different distances of shift may be used to produce multiple modal images to improve resolution. Additional collected shift images may be combined to further enhance the resolution of the image.

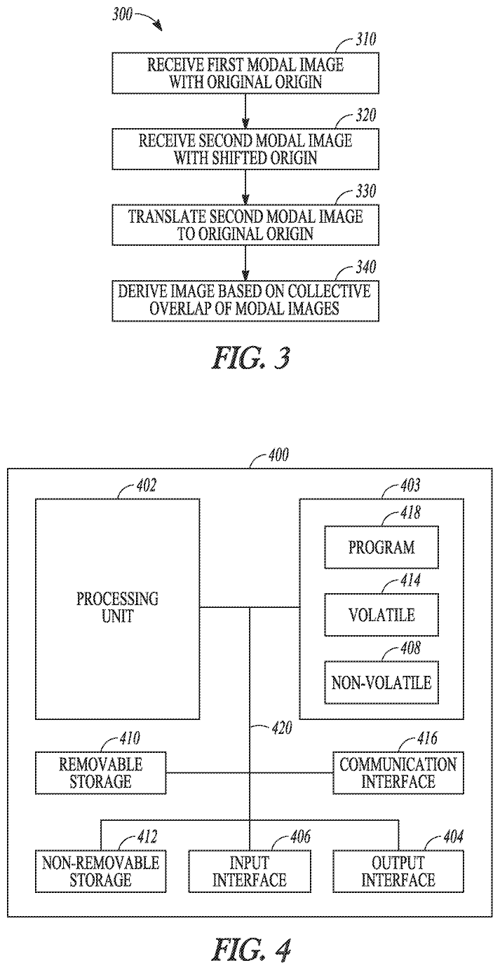

FIG. 3 is a flowchart illustrating a computer implemented method 300 of processing radiation received from an object to obtain an image of the object. Method 300 begins at operation 310 by receiving a first modal image based on radiation collected from an object via an aperture, wherein the radiation is separated into the first modal image having an original origin. A second modal image is received at operation 320 based on radiation collected from the object via the aperture, wherein the radiation is separated into the second modal image having a shifted origin. The second modal image is translated at operation 330 to the original origin. An image of the object is derived at operation 340 as a function of the collective overlap between the first modal image and the translated second modal image.

FIG. 4 is a block schematic diagram of a computer system 400 to receive and process radiation information according to example embodiments. All components need not be used in various embodiments.

One example computing device in the form of a computer 400 may include a processing unit 402, memory 403, removable storage 410, and non-removable storage 412. Although the example computing device is illustrated and described as computer 400, the computing device may be in different forms in different embodiments. For example, the computing device may instead be a smartphone, a tablet, smartwatch, smart storage device (SSD), or other computing device including the same or similar elements as illustrated and described with regard to FIG. 4. Devices, such as smartphones, tablets, and smartwatches, are generally collectively referred to as mobile devices or user equipment.

Although the various data storage elements are illustrated as part of the computer 400, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 400 may include or have access to a computing environment that includes input interface 406, output interface 404, and a communication interface 416. Output interface 404 may include a display device, such as a touchscreen, that also may serve as an input device. The input interface 406 may include one or more of a touchscreen, touchpad, mouse, keyboard, camera or other radiation collection device, one or more device-specific buttons, one or more sensors integrated within or coupled via wired or wireless data connections to the computer 400, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 400 are connected with a system bus 420.

Computer-readable instructions stored on a computer-readable medium are executable by the processing unit 402 of the computer 400, such as a program 418. The program 418 in sonic embodiments comprises software to implement one or more methods and algorithms described herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 418 along with the workspace manager 422 may be used to cause processing unit 402 to perform one or more methods or algorithms described herein.

### EXAMPLES

1. A method includes receiving a first modal image based on radiation collected from an object via an aperture, wherein the radiation is separated into the first modal image having an original origin, receiving a second modal image based on radiation collected from the object via the aperture, wherein the radiation is separated into the second modal image having a shifted origin, translating the second modal image to the original origin, and deriving an image of the object as a function of the collective overlap between the first modal image and the translated second modal image.

2. The method of example 1 wherein separation of the collected radiation is collected via a Hermite Gauss basis.

3. The method of any of the above examples wherein separation of the collected radiation is collected via a Laguerre Gauss basis.

4. The method of any of the above examples wherein the aperture is shifted to create the shifted origin.

5. The method of any of the above examples wherein the object is shifted to create the shifted origin.

6. The method of any of the above examples wherein atmospheric motion creates the shifted origin.

7. The method of any of the above examples wherein the second modal image is digitally translated to the original origin.

8. The method of any of the above examples wherein the aperture comprises a telescope.

9. The method of any of the above examples wherein the aperture comprises a microscope.

10. A computer implemented method includes receiving modal images based on radiation collected from an object via an aperture at an original origin and at multiple shifted origins, translating the modal images with shifted origins to the original origin, and deriving an image of the object as a function of the collective overlap between the modal images at the original origin.

11. A machine-readable storage device has instructions for execution by a processor of a machine to cause the processor to perform operations to perform a method. The operations include receiving a first modal image based on radiation collected from an object via an aperture, wherein the radiation is separated into the first modal image having an original origin, receiving a second modal image based on radiation collected from the object via the aperture, wherein the radiation is separated into the second modal image having a shifted origin, translating the second modal image to the original origin, and deriving an image of the object as a function of the collective overlap between the first modal image and the translated second modal image.

12. The device of any of the above examples wherein separation of the collected radiation is collected via a Hermite Gauss basis.

13. The device of any of the above examples wherein separation of the collected radiation is collected via of a Laguerre Gauss basis.

14. The device of any of the above examples wherein the aperture is shifted to create the shifted origin.

15. The device of any of the above examples wherein the object is shifted to create the shifted origin.

16. The device of any of the above examples wherein atmospheric motion creates the shifted origin.

17. The device of any of the above examples wherein second modal image is digitally translated to the original origin.

18. The device of any of the above examples wherein the aperture comprises a telescope.

19. The device of any of the above examples wherein the aperture comprises a microscope.

20. A device includes a processor, a radiation collector having an aperture to collect radiation from an object, and a memory device coupled to the radiation collector and the processor and having a program stored thereon for execution by the processor to perform operations. The operations include receiving a first modal image based on radiation collected from the object via the aperture, wherein the radiation is separated into the first modal image having an original origin, receiving a second modal image based on radiation collected from the object via the aperture, wherein the radiation is separated into the second modal image having a shifted origin, translating the second modal image to the original origin, and deriving an image of the object as a function of the collective overlap between the first modal image and the translated second modal image.

21. The device of any of the above examples wherein separation of the collected radiation is collected via a Hermite Gauss basis.

22. The device of any of the above examples wherein separation of the collected radiation is collected via a Laguerre Gauss basis.

23. The device of any of the above examples wherein the aperture is shifted to create the shifted origin.

24. The device of any of the above examples wherein object is shifted to create the shifted origin.

25. The device of any of the above examples wherein atmospheric motion creates the shifted origin.

26. The device of any of the above examples wherein the second modal image is digitally translated to the original origin.

27. The device of any of the above examples wherein the aperture comprises a telescope.

28. The device of any of the above examples wherein aperture comprises a microscope.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving a first modal image based on radiation collected from an object via an aperture, wherein the radiation is separated into the first modal image having an original origin;
receiving a second modal image based on radiation collected from the object via the aperture, wherein the radiation is separated into the second modal image having a shifted origin;
translating the second modal image to the original origin; and
deriving an image of the object as a function of the collective overlap between the first modal image and the translated second modal image.

2. The method of claim 1 wherein separation of the collected radiation is performed via a Hermite Gauss basis.

3. The method of claim 1 wherein separation of the collected radiation is performed via a Laguerre Gauss basis.

4. The method of claim 1 wherein the aperture is shifted to create the shifted origin.

5. The method of claim 1 wherein the object is shifted to create the shifted origin.

6. The method of claim 1 wherein atmospheric motion creates the shifted origin.

7. The method of claim 1 wherein the second modal image is digitally translated to the original origin.

8. The method of claim 1 wherein the aperture comprises a telescope.

9. The method of claim 1 wherein the aperture comprises a microscope.

10. The method of claim 1 wherein multiple modal images having different shifted origins are received, translated, and used to derive the image of the object.

11. A machine-readable storage device having instructions for execution by a processor of a machine to cause the processor to perform operations to perform a method, the operations comprising:
receiving a first modal image based on radiation collected from an object via an aperture, wherein the radiation is separated into the first modal image having an original origin;
receiving a second modal image based on radiation collected from the object via the aperture, wherein the radiation is separated into the second modal image having a shifted origin;
translating the second modal image to the original origin; and
deriving an image of the object as a function of the collective overlap between the first modal image and the translated second modal image.

12. The device of claim 10 wherein separation of the collected radiation is collected via a Hermite Gauss basis or a Laguerre Gauss basis.

13. The device of claim 10 wherein at least one of the aperture is shifted to create the shifted origin, the object is shifted to create the shifted origin, and atmospheric motion creates the shifted origin.

14. The device of claim 10 wherein the second modal image is digitally translated to the original origin.

15. The device of claim 10 wherein the aperture comprises a telescope, a microscope, or a camera.

16. A device comprising:
a processor;
a radiation collector having an aperture to collect radiation from an object; and
a memory device coupled to the radiation collector and the processor and having a program stored thereon for execution by the processor to perform operations comprising:
receiving a first modal image based on radiation collected from the object via the aperture, wherein the radiation is separated into the first modal image having an original origin;
receiving a second modal image based on radiation collected from the object via the aperture, wherein the radiation is separated into the second modal image having a shifted origin;
translating the second modal image to the original origin; and
deriving an image of the object as a function of the collective overlap between the first modal image and the translated second modal image.

17. The device of claim 16 wherein separation of the collected radiation is collected via a Hermite Gauss basis or a Laguerre Gauss basis.

18. The device of claim 16 wherein at least one of the aperture is shifted to create the shifted origin, the object is shifted to create the shifted origin, and atmospheric motion creates the shifted origin.

19. The device of claim 16 wherein the second modal image is digitally translated to the original origin.

20. The device of claim 16 wherein the aperture comprises a telescope, a microscope, or a camera.
